(19) United States
(12) Patent Application Publication
(10) Pub. No.: US 2016/0025513 A1
(43) Pub. Date: Jan. 28, 2016

(54) MULTI-SENSOR PEDOMETER

(71) Applicant: Amitabha BHATTACHARYYA, Saint Davids, PA (US)

(72) Inventor: Amitabha BHATTACHARYYA, Saint Davids, PA (US)

(21) Appl. No.: 14/444,147

(22) Filed: Jul. 28, 2014

(51) Int. Cl. G01C 22/00

(52) U.S. Cl. CPC G01C 22/006

(57) ABSTRACT

A multi-sensor pedometer is provided. The multi-sensor pedometer may include a first housing having a plurality of sidewalls forming an encased compartment. The plurality of sidewalls may provide at least one strap, a display and a sensing film. The compartment may house a control circuitry, a piezo-electric sensor and a power source. The control circuitry may provide an accelerometer and a step counting system including a step counter. A user may secure the multi-sensor pedometer around at least a portion of a predetermined muscle used during their exercise by connecting the at least one strap so that the sensing film operably interfaces the predetermined muscle. When the user prepares to exercise, the muscle contraction/bulge is conveyed through the sensing film to the electromechanically connected piezo-electric sensor, resulting in the step signal being sent to the control circuitry. The accelerometer transmits a motion signal to the control circuitry when it is detecting proper motion. The counting system counts at least one identifiable step when receiving the motion signal within a predetermined time of receiving any step signal. The control circuitry may electronically represent the summation of the at least one identifiable step and an associated plurality of exercise data on the display.

### BACKGROUND OF THE INVENTION

The present invention relates to a method, device and system for accurately measuring exercise performance and, more particularly, to a pedometer that accurately counts the steps of a user by two independent sensors of motion and muscle contraction.

A pedometer is a device that usually counts each step a person takes by detecting the motion of the person's hips. The accuracy of step counters varies widely between devices. Typically, step counters are placed on a belt, an arm or a wrist or otherwise far from the legs that take the steps to be counted. As a result, movement (or lack thereof) on any of these parts of the body for any other reason than walking or running may give a false reading. In other words, traditional pedometers give falsely counted steps when a user is driving a car or makes other habitual motions that the device encounters throughout the day. Moreover, pedometers get affected dramatically when jostled or otherwise shifted from their optimal placements during exercise. Considering that pedometers are used to maintaining healthy physical activity, errors can give users false measurements of what their activity is and so give false health-related information when the user is arranging their exercise regime within their lifestyle.

As can be seen, there is a need for an accurate pedometer that prevents the false counting of steps.

### SUMMARY OF THE INVENTION

In one aspect of the present invention, a multi-sensor pedometer comprises: a first housing having a plurality of sidewalls encasing a compartment; a sensing film disposed on at least a portion of one of the plurality of sidewalls, wherein the sensing film is configured to produce a predictable flexing when interfacing a predetermined muscle; an piezo-electric sensor housed within the compartment, wherein the piezo-electric sensor is electromechanically connected to the sensing film, and wherein the piezo-electric sensor is configured to transmit an electronic step signal for every predictable flexing thereof; an accelerometer housed within the compartment, wherein the accelerometer is configured to send a motion signal when proper acceleration is detected; and a control circuitry housed within the compartment, wherein the control circuitry is electronically connected to the piezo-electric sensor and the accelerometer, wherein the control circuitry is configured to count at least one identifiable step when receiving the motion signal within a predetermined time of receiving the step signal.

In another aspect of the present invention, the above aspect further provides counting system provided by the control circuitry, wherein the counting system comprises: a counting gate configured to electromechanically move from a closed position to an open position, wherein the counting gate occupies the closed position for the predetermined time after receiving the electronic step signal; and a step counter adapted to count the at least one identifiable step when the control circuitry receives the motion signal while the counting gate is in the closed position.

These and other features, aspects and advantages of the present invention will become better understood with reference to the following drawings, description and claims.

### BRIEF DESCRIPTION OF THE DRAWINGS

FIG. 1 is a front perspective view of an exemplary embodiment of the present invention;

FIG. 2 is a detailed perspective view of an exemplary embodiment of the present invention along line 2-2 of FIG. 1;

FIG. 3 is a rear perspective view of an exemplary embodiment of the present invention;

FIG. 4 is a rear perspective view of an exemplary embodiment of the present invention; and

FIG. 5 is a schematic perspective view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a multi-sensor pedometer. The multi-sensor pedometer may include a first housing having a plurality of sidewalls forming an encased compartment. The plurality of sidewalls may provide at least one strap, a display and a sensing film. The compartment may house a control circuitry, a piezo-electric sensor and a power source. The control circuitry may provide an accelerometer and a step counting system including a step counter. A user may secure the multi-sensor pedometer around at least a portion of a predetermined muscle used during their exercise by connecting the at least one strap so that the sensing film operably interfaces the predetermined muscle. When the user prepares to exercise, the muscle contraction/bulge is conveyed through the sensing film to the electromechanically connected piezo-electric sensor, resulting in the step signal being sent to the control circuitry. The accelerometer transmits a motion signal to the control circuitry when it is detecting proper motion. The counting system counts at least one identifiable step when receiving the motion signal within a predetermined time of receiving any step signal. The control circuitry may electronically represent the summation of the at least one identifiable step and an associated plurality of exercise data on the display.

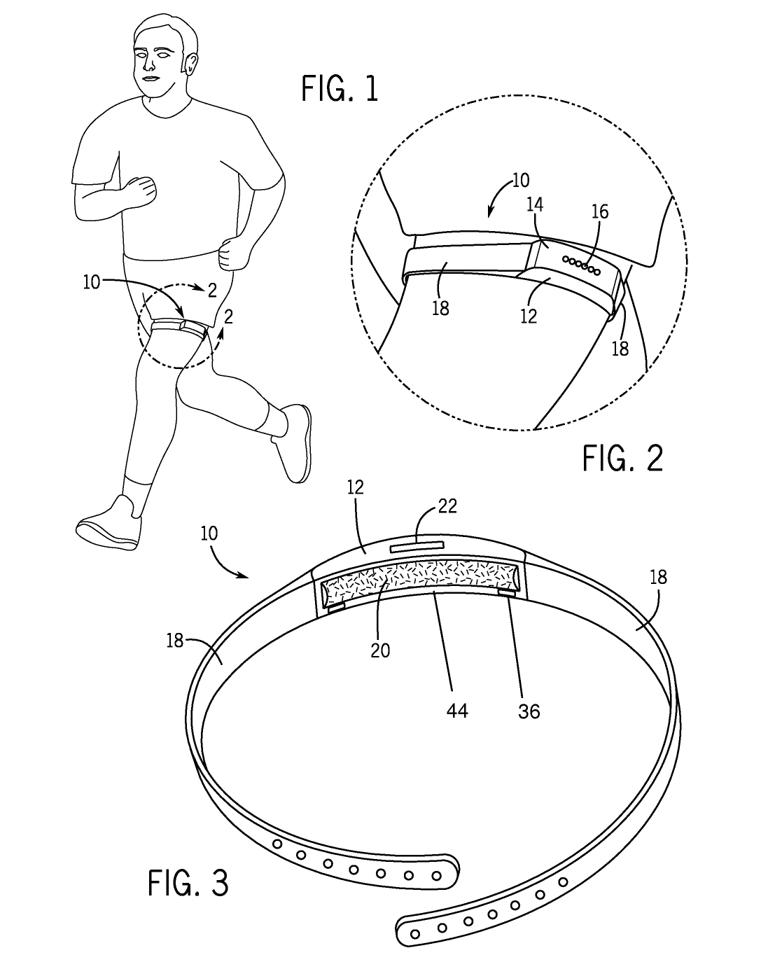

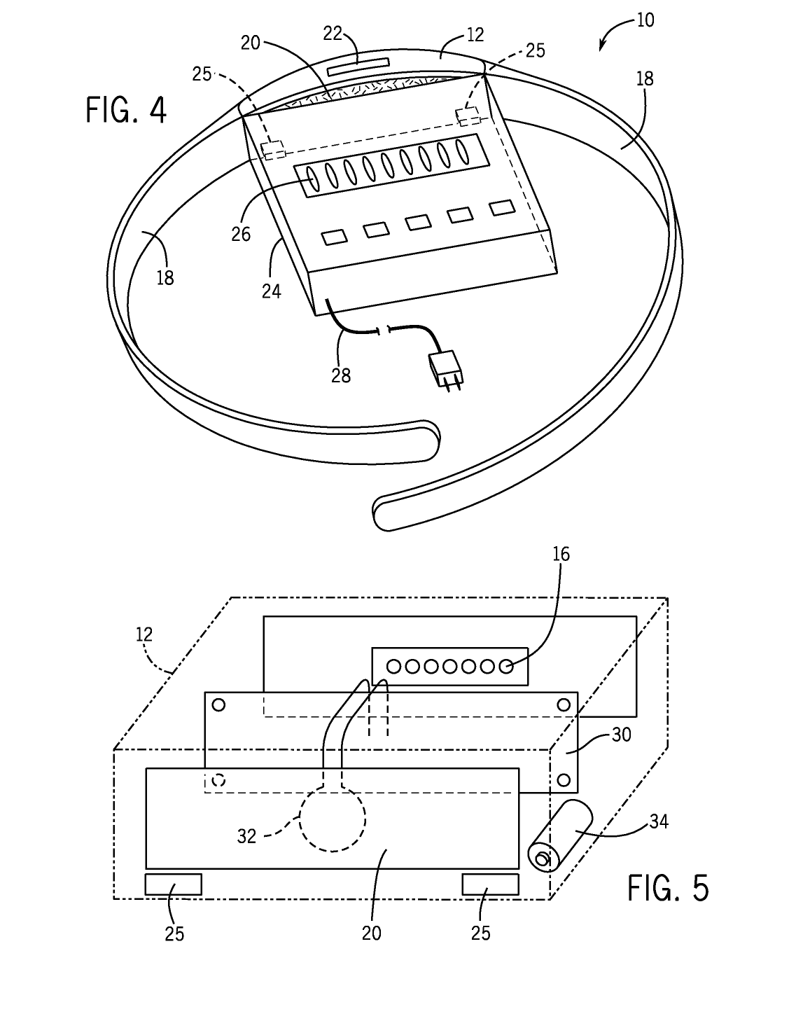

Referring to FIGS. 1 through 5, the present invention may include a multi-sensor pedometer 10. The multi-sensor pedometer 10 may include a first housing 12, at least one strap 18 and a control circuitry 30 having an accelerometer. The at least one strap 18 may be adapted to removably secure the first housing 12 to a wearer by connecting to at least one of the plurality of sidewalls.

The first housing 12 may include a plurality of sidewalls encasing a compartment. The first housing 12 may include a display 16 and a reset button 22 disposed on at least one of the plurality of sidewalls. The first housing 12 may house the control circuitry 30, a piezo-electric sensor 32 and a power source 34 within the compartment. The first housing 12 may define at least one female port 36 on at least one of the plurality of sidewalls.

The plurality of sidewalls may include a display side 14 and a sensing side 44. The display side 14 may define the display 16. The display 16 may be electronically connected to the control circuitry 30. The display 16 may produce electronic representations of the steps taken, energy expended, velocity, acceleration, distance traveled, distance per step and the like.

The sensing side 44 may include a sensing film 20. The sensing film 20 may be a thin sheet that provides an interface between the skin of the user and the piezo-electric sensor 32. The sensing film 20 may be made of material that reacts and/or flexes in a predictable manner following the application of force to its surface. The predictable manner of flexing may be electromechanically transmitted in the form of a predictable flexing. For example, the sensing film 20 may interface with the thigh muscle of the user so that the contraction of the thigh muscle as the user gaits causes the predictable flexing in the sensing film 20 indicative of the gait of the user.

The first housing 12 may terminate in connections to at least one strap 18 for adjustably securing the multi-sensor pedometer 10 to a user. The strap 18 may be made of non-stretch material adapted to ensure reliable interfacing contact between the sensing film 20 and the skin of the user during operation so that the piezo-electric sensor 32 may accurately determine the initiation of steps of the user.

The piezo-electric sensor 32 may be electromechanically connected to the sensing film 20. The piezo-electric sensor 32 may be electronically connected to the control circuitry 30. The piezo-electric sensor 32 may be adapted to send an electronic step signal to the control circuitry 30 when the piezo-electric sensor 32 receives the predictable flexing of the sensing film 20 consistent with the gait or step of the user.

The control circuitry 30 may be electrically connected to the power source 34. The power source 34 may be a rechargeable battery, voltage regulator or the like. The control circuitry 30 may include at least one processing unit and a form of memory, such as a computer, microprocessor or the like. The control circuitry 30 may be adapted to store and transmit electronic data as output. The control circuitry 30 may be electronically connected to the accelerometer and/or a device that measures proper acceleration. The accelerometer may be adapted to detect that the forward motion by the user wearing the multi-sensor pedometer 10. The accelerometer may be adapted to send an electronic motion signal when such motion has been established.

The control circuitry 30 may be adapted to provide a step counting system by sensor fusion. The step counting system may include a counting gate/switch and a step counter. The counting gate may electromechanically move from a closed position to an open position and vice-versa. The counting gate may be adapted to occupy the closed position upon receiving the step signal from the piezo-electric sensor 32. The gate remains closed for approximately 30 milliseconds. The step counter may store a counted step when the control circuitry 30 receives the motion signal while the counting gate is in the closed position. The control circuitry 30 may be adapted to identify a plurality of steps taken by summarizing the number of identified steps during the whole exercise. Likewise the control circuitry 30 may be adapted to evaluate the motion signals, step signals and a plurality of inputted data so as to determine a plurality of exercise data such as the energy expended, velocity, acceleration, distance traveled, distance per step and the like, of the user and produce electronic representations thereof. The plurality of inputted data may include user weight, data on the predetermined muscle and the like.

The present invention has advantageous applications over the prior art that relies on electromyographical (EMG) sensors, which evaluate the electrical activity produced by muscle contractions during walking or running. First, EMG sensors require skin preparation prior to placement, and the actual placement of the electrodes can be difficult and depend on a number of factors including specific muscle selection and the size of that muscle. Also, the more body fat an individual has, the weaker the EMG signal. On the other hand, the piezo-electric sensor 32 may require a relatively simple interface and can operate satisfactorily in moderately hostile environments.

In certain embodiments, the multi-sensor pedometer 10 may include a docking station 24. The docking station 24 may include at least one male port 25 adapted to electronically connect to the at least one female port 36 so that the docking station 24 may download the plurality of exercise data while, at the same time, charge the multi-sensor pedometer 10 and or the power source 34. The docking station 24 may store the plurality of exercise data over long periods and makes it available for viewing on demand. The docking station 24 may also transmit the inputted data about the user, such as body weight, length of gait and the like, to the control circuitry 30 for determining the plurality of exercise data.

A method of using the present invention may include the following. The multi-sensor pedometer 10 disclosed above may be provided. A user may secure the multi-sensor pedometer 10 around at least a portion of a predetermined muscle used during their exercise. Such as the thigh muscle when the user is counting the steps of walking. The predetermined muscle may include another leg muscle and/or muscle group, a foot muscle and/or muscle group, and/or an abdominal muscle and/or muscle group. The multi-sensor pedometer 10 may be secured by connecting the at least one strap 18 so that the sensing film 20 operably interfaces and/or reliably contacts the predetermined muscle so that the contraction or bulge of the predetermined muscle generates an accurate step signal. Then the user may press the reset button 22 so that the control circuitry 30 runs a preliminary test of all components and gets ready for the step signals and the motion signals. At this stage, the sensing film 20 applies a threshold pressure on the piezo-electric sensor 32 so that the control circuitry 30 determines the threshold values. The display 16 shows zero reading. When the user prepares to walk/run, the muscle bulge is conveyed to the piezo-electric sensor 32 through the sensing film 20, the forward movement is detected and the motion signal sent by the accelerometer so that the first step and all subsequent steps in the journey is counted by the step counting system, and electronically represented on the display 16.

In certain embodiments the multi-sensor pedometer 10 may be secured about other parts of the user's leg, including the ankle and the like.

In certain embodiment, the multi-sensor pedometer 10 may be used on animals for biometrics testing, gait analysis and the like.

It should be understood, of course, that the foregoing relates to exemplary embodiments of the invention and that modifications may be made without departing from the spirit and scope of the invention as set forth in the following claims.

What is claimed is:

1. A multi-sensor pedometer comprising:
a first housing having a plurality of sidewalls encasing a compartment;
a sensing film disposed on at least a portion of one of the plurality of sidewalls, wherein the sensing film is configured to produce a predictable flexing when interfacing a predetermined muscle;
an piezo-electric sensor housed within the compartment, wherein the piezo-electric sensor is electromechanically connected to the sensing film, and wherein the piezo-electric sensor is configured to transmit an electronic step signal for every predictable flexing thereof;
an accelerometer housed within the compartment, wherein the accelerometer is configured to send a motion signal when proper acceleration is detected; and
a control circuitry housed within the compartment, wherein the control circuitry is electronically connected to the piezo-electric sensor and the accelerometer, wherein the control circuitry is configured to count at least one identifiable step when receiving the motion signal within a predetermined time of receiving the step signal.

2. The multi-sensor pedometer of claim 1, further providing at least one strap connected to the first housing.

3. The multi-sensor pedometer of claim 1, wherein the predictable flexing is produced when the predetermined muscle is involved in taking an identifiable step.

4. The multi-sensor pedometer of claim 1, further providing a display along a portion of one of the plurality of sidewalls, wherein the control circuitry is electronically connected to the display so as to display electronic representations of an output of the control circuitry.

5. The multi-sensor pedometer of claim 1, further providing at least one male port along a portion of the plurality of sidewalls, wherein the at least one male port is configured to transmit the output of the control circuitry.

6. The multi-sensor pedometer of claim 1, further providing a counting system provided by the control circuitry, wherein the counting system comprises:
a counting gate configured to electromechanically move from a closed position to an open position, wherein the counting gate occupies the closed position for the predetermined time after receiving the electronic step signal; and
a step counter adapted to count the at least one identifiable step when the control circuitry receives the motion signal while the counting gate is in the closed position.

7. The multi-sensor pedometer of claim 1, wherein the predetermined time is approximately 30 milliseconds.

8. The multi-sensor pedometer of claim 1, wherein the control circuitry 30 is configured to sum the at least one identifiable steps.

9. The multi-sensor pedometer of claim 1, wherein the control circuitry is configured to of evaluate the motion signals, the electronic step signals and a plurality of inputted data so as to determine a plurality of exercise data regarding the energy expended, velocity, acceleration, distance traveled, and distance per step.

10. A method of counting steps comprising:
providing a multi-sensor pedometer comprising: a first housing having a plurality of sidewalls encasing a compartment; a sensing film disposed on at least a portion of one of the plurality of sidewalls, wherein the sensing film is configured to produce a predictable flexing when interfacing a predetermined muscle; an piezo-electric sensor housed within the compartment, wherein the piezo-electric sensor is electromechanically connected to the sensing film, and wherein the piezo-electric sensor is configured to transmit an electronic step signal for every predictable flexing thereof; an accelerometer housed within the compartment, wherein the accelerometer is configured to send a motion signal when proper acceleration is detected; a control circuitry housed within the compartment, wherein the control circuitry is electronically connected to the piezo-electric sensor and the accelerometer, wherein the control circuitry is configured to count at least one identifiable step when receiving the motion signal within a predetermined time of receiving the step signal; and at least one strap connected to the first housing; and
securing the at least one strap to a user so that the sensing film interfaces with the predetermined muscle.

11. The method of claim 10, further providing a counting system integrated with the control circuitry, wherein the counting system comprises: a counting gate configured to electromechanically move from a closed position to an open position, wherein the counting gate occupies the closed position for the predetermined time upon receiving the electronic step signal; and a step counter adapted to count the at least one identifiable step when the control circuitry receives the motion signal while the counting gate is in the closed position.

12. The method of claim 10, wherein the predetermined muscle is in the user's leg.

13. The method of claim 10, wherein the predetermined muscle is in the user's foot.

14. The method of claim 10, wherein the predetermined muscle is in the user's abdomen.
